(19) United States
(12) Patent Application Publication
(10) Pub. No.: US 2021/0158625 A1
(43) Pub. Date: May 27, 2021

(54) SYSTEM HAVING PREDICTIVE ANALYTICS AND CUSTOM VISUALIZATION FOR USE IN IMAGING A VEHICLE OCCUPANT AND METHOD OF USE

(71) Applicants: Jonathan Rayos, Sterling Heights, MI (US); Michael Angelo D'Orazio, Farmington Hills, MI (US)

(72) Inventors: Jonathan Rayos, Sterling Heights, MI (US); Michael Angelo D'Orazio, Farmington Hills, MI (US)

(21) Appl. No.: 17/105,818

(22) Filed: Nov. 27, 2020

Related U.S. Application Data
(60) Provisional application No. 62/941,150, filed on Nov. 27, 2019.

(51) Int. Cl. G06T 19/00; G06K 9/00

(52) U.S. Cl. CPC G06T 19/006; G06T 2219/028; G06K 9/00832

(57) ABSTRACT

The disclosed inventive concept provides a system and method incorporating extended reality, augmented reality, virtual reality, and artificial intelligence. The disclosed system and method utilizes these technologies to provide solutions to both the need for real-time medical diagnosis as well as improved crash testing. Through the utilization of real-time 3D imaging, extended reality data, augmented reality data, and artificial intelligence, an actual real-time emergency or non-emergency medical response to an impact event provides immediate diagnostic information through predictive analytics from collective data to emergency medical services and hospital medical personnel. The inventive concept also provides an improved approach to vehicle impact testing. Through the utilization of a real-time 3D, extended reality dashboard, enhanced augmented reality, and machine learning with artificial intelligence datasets, the present invention moves the technology beyond conventional physical impact testing into multiple areas such as the dummies used in known physical tests plus other expanded testing protocols.

### TECHNICAL FIELD

The disclosed inventive concept relates to predictive analytics and custom visualization for use in relation to an automotive vehicle. More particularly, the disclosed inventive concept relates to such analytics and visualization for use by emergency response teams and for use in automotive impact testing. The disclosed system provides real-time data mining of occupant reactions and physical bodily changes during an actual emergency or non-emergency impact event for use by emergency response teams. The disclosed system assists vehicle manufacturers and industrial suppliers in the replacement of conventional physical prototype testing using virtual replication in various environments.

### BACKGROUND OF THE INVENTION

Impact events involving automobiles may be both accidental and, as the result of vehicle testing, deliberate. Accidental automotive impact events are the leading cause of death in the United States for persons aged 1-54 with almost 40,000 people dying every year in vehicle accidents. Over four million people are injured annually in the United States in vehicle impact events seriously enough to require medical attention. Many of these fatalities could have been prevented and the injuries reduced if immediate medical attention was provided. Because automotive impact events today do not provide real-time physical injury data to emergency medical services (EMS) personnel, the ability to provide faster medical assistance is often compromised by time lost by medical personnel in diagnosing the scope of the actual injuries.

Recognizing the role vehicles play in fatalities and injuries, auto makers continuously attempt to improve the safety of their products. An important step in the improvement of vehicle safety is automobile impact testing. Only independent automotive crash tests under controlled conditions can differentiate one car from another and determine just how well a car performs under crash conditions.

However, dummies currently used in virtual crash simulations are unable to simulate the reflexive defensive actions that humans take in the moments before an imminent collision, such as bracing one's body for impact. Thus today's physical crash dummy cannot currently assess danger and therefore cannot replicate a human occupant's real behavior.

Accordingly, there is a need in the automotive industry to provide improvements in both the sensing and interpretation of an impact event on the vehicle occupants, whether the impact event is accidental or intentional.

### SUMMARY OF THE INVENTION

The disclosed inventive concept overcomes the challenges faced by known medical responses and vehicle impact testing by providing a system and method incorporating advancements in the emerging broad area of extended reality (XR) which includes augmented reality (AR), virtual reality (VR), artificial intelligence (AI), and machine learning (ML) with additional “reality” technologies being developed. These immersive technologies focus on expanding the real world by various mechanisms, including the blending of both the virtual and the real world as well as formulating a completely immersive experience.

In the case of augmented reality, the real world is modified by the use of virtual information and objects. This may involve the overlaying of virtual information and objects on elements of the real world whereby users are able to interact with the real world but in its modified or “augmented” form.

Conversely, in virtual reality the user is immersed fully in a simulated digital environment. This area of technology is most often used by the gaming world but is becoming more common in other areas, such as in the healthcare industry as well as in the military.

The present inventive concept advantageously utilizes advancements in these technologies to provide solutions to both the need for real-time medical diagnosis as well as improved crash testing. Through the utilization of real-time 3D imaging, extended reality data, augmented reality data, artificial intelligence, and related software, an actual real-time emergency or non-emergency medical response to an impact event provides immediate diagnostic information through predictive analytics from collective data to emergency medical services (EMS) and hospital medical personnel.

The present inventive concept also provides an improved approach to vehicle impact testing. Through the utilization of a real-time 3D, extended reality dashboard, enhanced augmented reality, machine learning with artificial intelligence datasets, and related software, the disclosed system and method moves the technology beyond conventional physical impact testing into multiple areas such as the dummies used in the current physical tests plus other expanded testing protocols.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a flowchart illustrating the operation of the disclosed inventive concept;

FIG. 2 is a side elevational view of a vehicle interior showing the primary components of the disclosed inventive concept;

FIG. 3 is a top perspective view of the vehicle interior shown in FIG. 1;

FIG. 4 is a top plan view of a vehicle impact test showing a vehicle about to impact a first barrier arrangement;

FIG. 5 is a top plan view of a vehicle impact test showing a vehicle about to impact a second barrier arrangement;

FIG. 6 is a top plan view of a vehicle impact test showing a vehicle about to impact a third barrier arrangement;

FIG. 7 is a top plan view of a vehicle impact test showing a vehicle about to be impacted by a movable barrier;

FIG. 8 is a side elevational view a vehicle impact test showing a vehicle fixed on a rigid surface being impacted by a moving force;

FIG. 9 is a front elevational view a vehicle impact test showing a vehicle fixed on a rigid surface being impacted by a moving force;

FIG. 10 is a diagrammatic view of a head restraint geometry as used in regulatory and consumer testing;

FIG. 11 is a side elevational view of a vehicle seat as an example of an international measurement standard for the sat head restraint;

FIG. 12 is an Extended Reality (XR) and Augmented Reality (AR) visualization of a simulated impact event involving a crash test dummy according to the disclosed inventive concept; and

FIG. 13 is an X-ray visualization of an Extended Reality (XR) and Augmented Reality (AR) used in a simulated impact event according to the disclosed inventive concept.

### DETAILED DESCRIPTION OF THE PREFERRED EMBODIMENTS

In the following figures, the same reference numerals will be used to refer to the same components. In the following description, various operating parameters and components are described for different constructed embodiments. These specific parameters and components are included as examples and are not meant to be limiting.

The system incorporates pre-installed databases, analysis tool programs, and interpretive software including programs for applying an enhanced reality program to the captured images. The interpretive software programs interpret images received by image capturing devices associated with a vehicle. The interpretive software program utilizes extended reality, enhanced augmented reality, artificial intelligence, and machine learning datasets to interpret any injury caused by an impact event in real time and, when used in a vehicle impact involving one or more consumer vehicles, provides an analysis of the injury and a recommended course of treatment.

When operating in its injury analysis and recommended treatment mode, the software summarizes, organizes, and manages diagnostic data. The diagnostic data may be organized in a specific format, such as assessing and recommending treatment of an injury to a specific internal organ. The software program further enables the data related to the identification and extent of the specific injury as well as a recommended course of treatment to be transmitted from the local network integrated with the vehicle to a remotely located server for use by medical personnel. The preloaded software may include application programs and analysis tool programs.

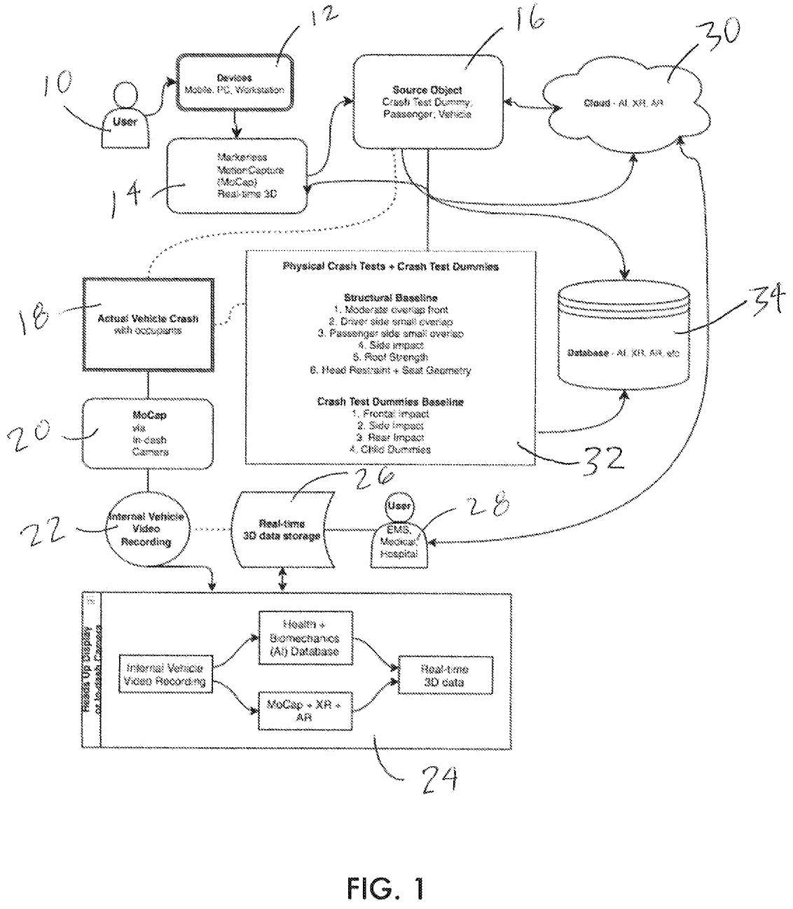

Referring to FIG. 1 a flowchart illustrating the operation of the disclosed inventive concept is shown. It is to be understood that the illustrated flowchart is to be considered as a preferred arrangement but not an exclusive arrangement as it is possible that one or more changes may be made to the flowchart without deviating from the scope of the invention as described.

The flowchart of FIG. 1 may be universally applied to medical assistance in a vehicle impact event as well as to an improved arrangement for controlled vehicle impact testing for the improvement of vehicle safety. Accordingly, a portion of the flowchart of FIG. 1 is directed primarily to use of the system to apprise medical personnel of the status of the vehicle and its occupants, a portion of the flowchart is directed primarily to use of the system for crash testing, and a portion of the flowchart is common to both uses.

Flowchart—Common Aspects

As illustrated in FIG. 1, one or more users 10 operates the underlying system by means of any of several possible devices 12, such as but not limited to a mobile device, a personal computer, or a fixed or mobile workstation. Such devices may be used alone or in conjunction with one another as required to perform the operation.

Regardless of the user-operated device employed, one or more motion capturing devices 14 are linked to the device. The motion capturing device 14 (“MoCap”) may be of any device capable of capturing (or tracking) the movement of objects but is preferably of the markerless variety. However, other suitable image capturing arrangements are possible.

More particularly, two or more motion capturing devices are ordinarily used to triangulate the 3D location of the object being captured. Additional capturing devices are used as needed to capture a possible range of motion as used herein to capture the movement of a test vehicle during an impact analysis. Conventionally a marker recognizable to the motion capturing device was fitted to the object or individual being captured. A variety of markers, such as passive markers, active markers (including time modulated active markers), and semi-passive “imperceptible” markers, have been used for this purpose. However, more recently markerless systems do not require the use of markers but instead on computer algorithms that review and analyze several streams of optical input to thereby allow object tracking. The disclosed inventive concept preferably but not absolutely utilizes markerless real-time 3D motion capturing devices in both the consumer vehicle as well as in the vehicle used in automotive impact testing.

The flowchart of FIG. 1 specifies a process 16 including the creation of a query—source objects—specifying the data selected for retrieval. The data may include any of the following: the status of one or more vehicle occupants in the consumer vehicle, the status of the consumer vehicle, the status of the crash test dummy, and the status of the crash test vehicle.

Flowchart—Consumer Vehicle Monitoring

Data retrieval at the process 16 may be directed to the monitoring of a consumer vehicle in ordinary operation. The vehicle monitoring may be done for both emergency and non-emergency purposes although the system of the disclosed inventive concept is particularly useful in an impact event where time for the receipt of medical attention is critical. Accordingly, the process 16 may draw data from an actual vehicle crash with occupants at process 18. One or more in-dash, heads-up display, or other cabin-based image capturing devices 20 capture images of the vehicle occupants and the vehicle during and after an impact event. An internal vehicle recording system 22 memorializes the captured data. The recording system 22 allows for sequential access of the contained data.

The captured data is subjected to analysis and interpretation at process 24 wherein the recorded data is subjected to review both by a health and biomechanics artificial intelligence database and by extended reality and augmented reality databases. The review results in real-time 3D data which may be stored in any format as stored data 26.

At this stage the extent of injury and damage to the vehicle is assessed and predictive analytics from the stored collective data reflecting other impact events and similar injuries are analyzed. Extended reality and augmented reality programming may, for example, superimpose upon the real crash victim an x-ray of likely internal injury not only to bones but also to internal organs, thereby providing real-time diagnostic information to emergency medical services before the injured occupant is even physically seen by a first responder. These images are viewed and considered by emergency personnel 28 via a cloud-based exchange 30 in anticipation of either arriving at the accident scene or the arrival of the injured vehicle occupant at a medical facility, thereby eliminating almost entirely time that would otherwise be spent in triage identifying the injuries and determining a course of action. Instead, using the system of the disclosed inventive concept, medical personnel may begin administering a prescribed treatment almost immediately.

Flowchart—Vehicle Crash Testing

Data retrieval at the process 16 may alternatively be directed to the monitoring of a test vehicle and dummy occupants during a controlled impact event. By placing an array of motion capturing devices in the cabin of a test-vehicle, images showing occupant injuries may be enhanced by extended reality, enhanced augmented reality, artificial intelligence, and machine learning datasets according to the disclosed inventive concept. By applying the interpretive software that enhances the reality of the test impact event, the accurate modeling of pre-collision human movements to various other parameters such as muscle tension while pre-braking, and behaviors of drivers during a high alert situation can be created, thereby moving crash testing technology beyond conventional physical impact testing into multiple areas such as to the dummies used in physical testing.

Using the disclosed method and system to establish a structural baseline for the vehicle, several impact tests may be undertaken that include, but are not limited to, moderate overlap front impact (formerly known as a “frontal offset test”), driver side small overlap impact, passenger side small overlap, side impact, roof strength test, and the head restraint/seat geometry test method. This data is collected at process 32—“Physical Crash Tests+Crash Test Dummies.”

The disclosed method and system also provide for the establishment of a structural baseline for crash test dummies. These impact tests include, but are not limited to, frontal impact, side impact, rear impact, and child dummies. This data is also preferably collected at process 32—“Physical Crash Tests+Crash Test Dummies.”

The data gathered at process 32 is analyzed by a database 34. The data contained in the database 34 can apply extended reality, augmented reality, artificial intelligence, virtual reality, and machine learning to the data generated at process 32.

The analysis provided by the system and method of the disclosed inventive concept generates improved crash test simulations and represents a more accurate outcome for a virtual vehicle occupant in an impact than is possible by today's crash testing.

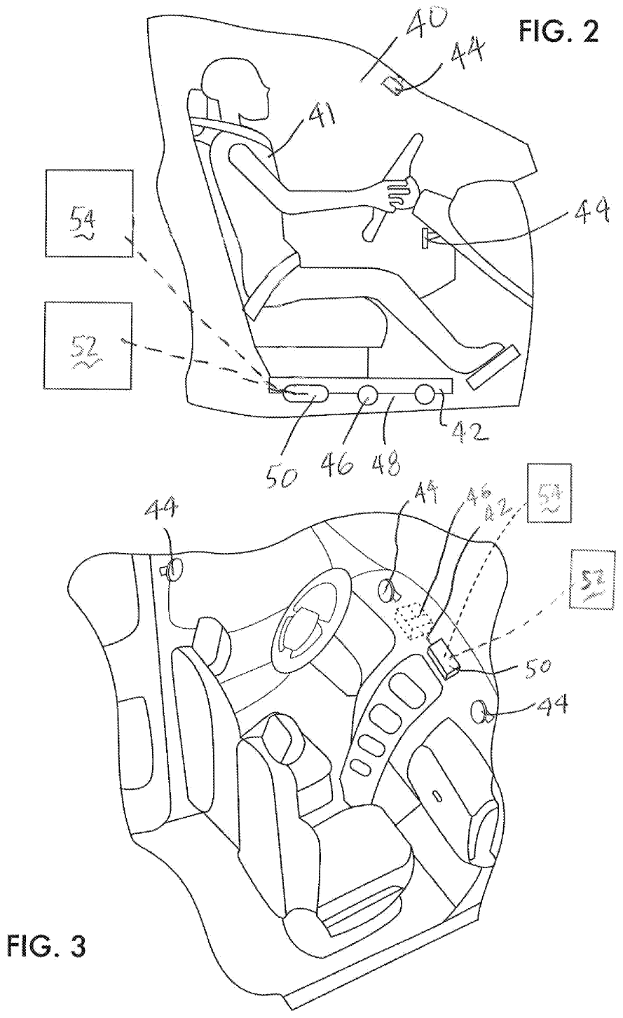

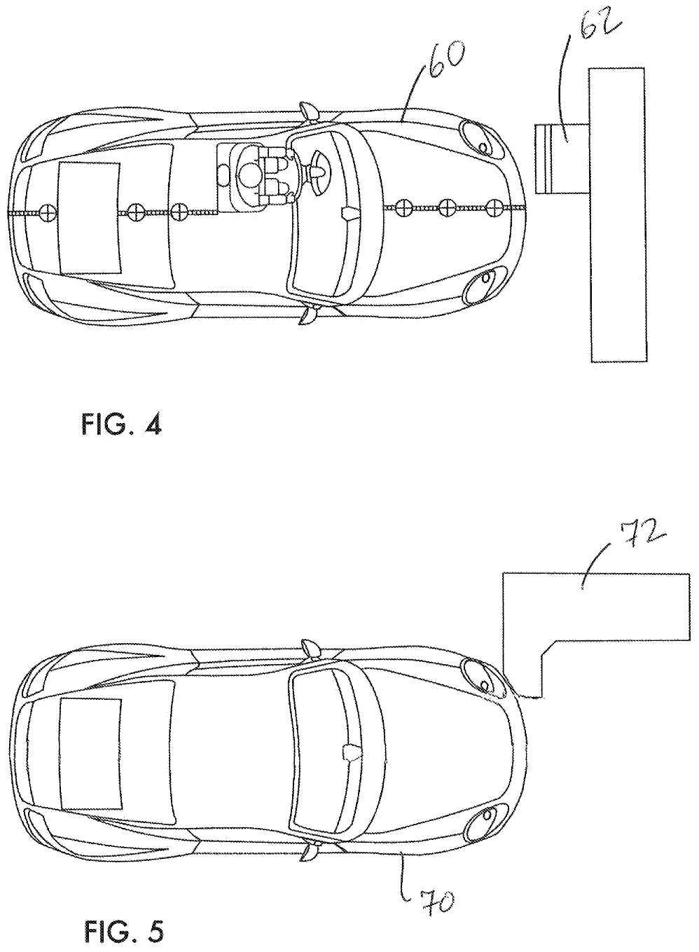

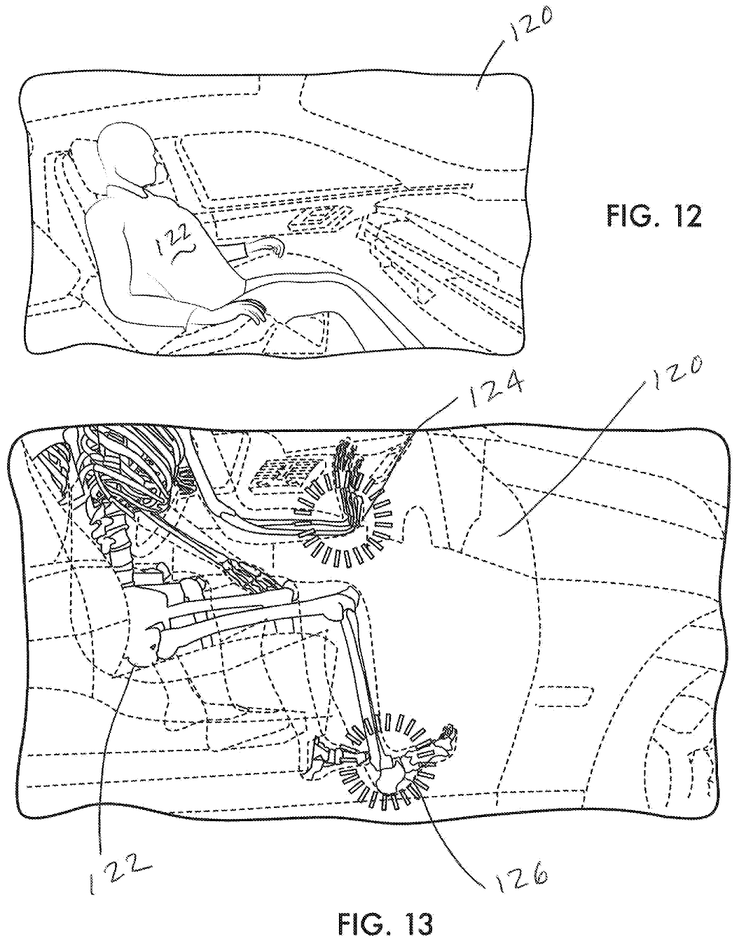

FIGS. 2 and 3 illustrate a vehicle interior fitted with appropriate image capturing and data communication components for use in a consumer vehicle. FIGS. 4 through 9 illustrate various vehicles undergoing crash testing. FIGS. 10 and 11 relate to head restraint and seat geometry testing methods. FIGS. 12 and 13 illustrate a test dummy as viewed using the technology of the disclosed system and method.

Referring to FIGS. 2 and 3, a side elevational view and a top perspective view of a vehicle interior showing the primary components of the disclosed inventive concept are respectively illustrated. While an automotive vehicle is illustrated, it is to be understood that the disclosed inventive concept may find application in any number of vehicles, including both automotive vehicles and trucks.

FIGS. 2 and 3 illustrate views of an automotive vehicle interior, generally illustrated as 40, showing the primary components of the disclosed inventive concept required for image capturing and data transmission. An occupant 41 is illustrated in a pre-impact seated position. While an automotive vehicle interior is illustrated it is to be understood that the disclosed inventive concept may also be used in any other situation involving a possible occupant injury rendering the person incapable of responding to the accident situation. As discussed above, the gathered and interpreted information is sent to a remote emergency service for use in preparing a medical response.

An embedded image capturing and communication network 42 is incorporated into the vehicle in association with the interior 42. The network 42 includes an array of image capturing devices 44 strategically located in the interior 42. They image capturing devices 44 may be located in relation to the vehicle dashboard, one or more of the pillars, and in the vehicle headrests for a rear-seat view of the interior 42. A wireless communication device 46 is provided in relation to the interior 42. The wireless communication device 46 may be fixed in relation to the vehicle's interior 40 or may be a portable communication device such as the cell phone of a vehicle occupant.

The embedded image capturing and communication network 42 may include a a controller area network (CAN) bus 48 for monitoring the network 42 to identify the occurrence of an impact event. The controller area network bus 48 includes devices such as microcontrollers to link the image capturing devices and other components of the network 42 without the need for an on-board host computer.

A data gathering and interpreting center 50 operates in conjunction with the wireless communication device 46. The data gathering and interpreting center 50 also operates in conjunction with a remote health and biomechanics database 52 to gather information related to the captured enhanced reality images illustrating the injury according to the disclosed inventive concept, determine the scope of the injuries, and prepare a recommended course of treatment. This information is then forwarded to a medical care provider 54.

As noted, FIGS. 4 through 9 illustrate various vehicles undergoing crash testing. Data gathered from each of the illustrated impact events can be enhanced according to the disclosed inventive concept. In each instance the image capturing devices operate in conjunction with extended and augmented reality software that provides to the test operator data illustrating the injury to the dummy in a format that accurately represents the injury had it occurred to a human occupant. Known technologies related to crash testing are incapable of providing such a complete and accurate image of actual injuries.

Referring to FIG. 4, a top plan view of a moderate overlap front impact test (formerly known as a frontal offset test) showing a vehicle 60 about to impact a fixed barrier arrangement 62 is illustrated. The interior of the vehicle 60 is fitted with an array of image capturing devices.

Referring to FIG. 5, a top plan view of a driver side small overlap impact test showing a vehicle 70 about to impact a fixed barrier arrangement 72 is illustrated. The interior of the vehicle 70 is fitted with an array of image capturing devices.

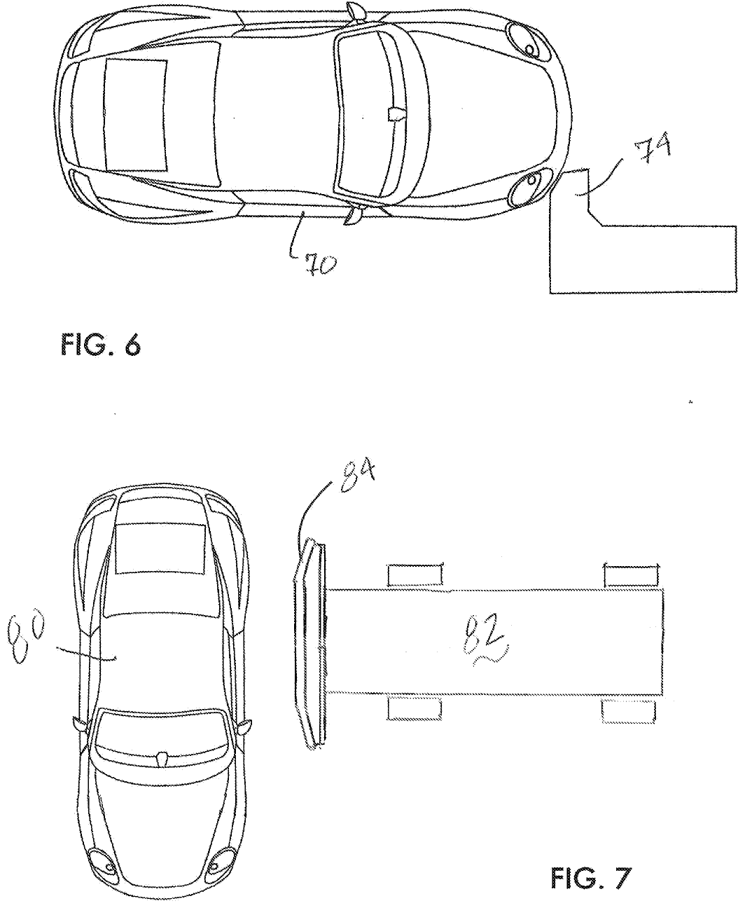

Referring to FIG. 6, a top plan view of a passenger side small overlap impact test showing the vehicle 70 about to impact a fixed barrier arrangement 74 is illustrated.

Referring to FIG. 7, a top plan view of a stationary test vehicle 80 about to be impacted by a cash cart 82 fitted with a deformable barrier element 84 is illustrated. The interior of the vehicle 80 is fitted with an array of image capturing devices.

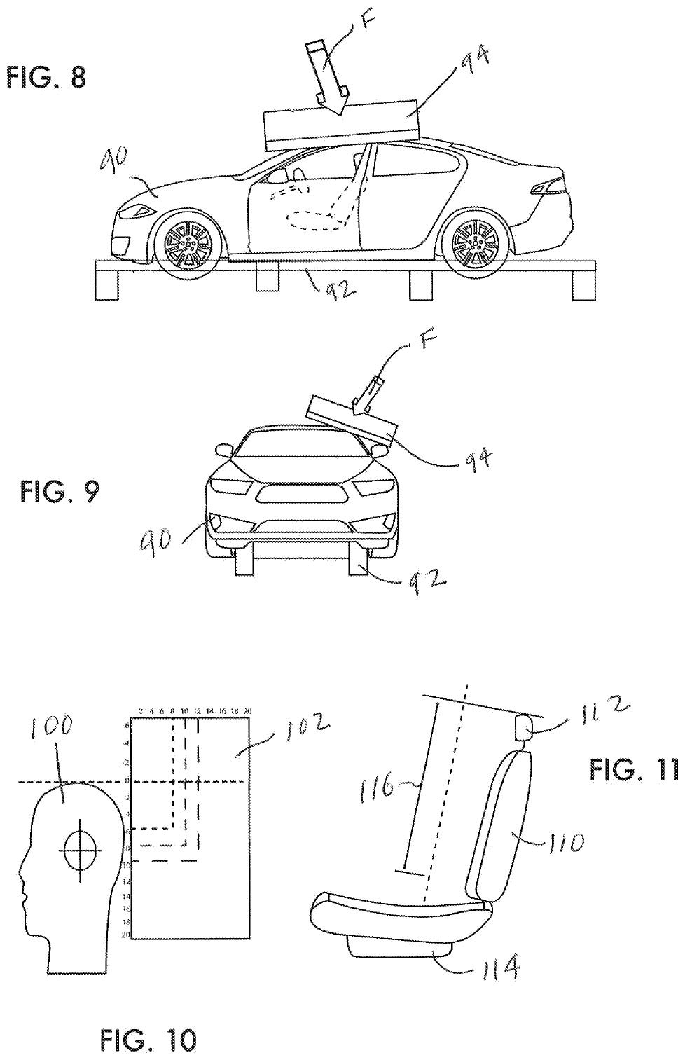

Referring to FIG. 8, a side elevational view of a stationary test vehicle 90 mounted on a rigid horizontal surface 92 being impacted by an angled loading device 94 is illustrated applying a Force F. This arrangement illustrates one roof strength crash test. The interior of the vehicle 90 is fitted with an array of image capturing devices.

Referring to FIG. 9, a side elevational view of the stationary test vehicle 90 mounted on the rigid horizontal surface 92 being impacted by the angled loading device 94 applying a Force F is illustrated. The rigid horizontal surface 92 is applying an impact in a location other than that shown in FIG. 8. This arrangement illustrates another roof strength crash test.

As noted, FIGS. 10 through 11 illustrate head restraint and seat geometry testing methods. The Research Council for Automobile Repairs (RCAR) developed standards that evaluate and rate to what degree forward facing front seats and head restraints prevent neck injury in vehicle impact events. Evaluation procedures involve the measurement of head restraint geometry relative to the average size adult male. These are static evaluations involving the measurement of the height and backset of a vehicle seat made using a dummy.

As illustrate din FIG. 10, to rate a head restraint the head 100 of a dummy is positioned relative to a backset geometry 102 to determine the distance from the top of the head 100 as compared with the backset geometry 102. Various possible ratings include “good,” “acceptable,” and “marginal” as indicated by the backset geometry 102.

Another testing protocol related to the testing of head and restraint geometry is illustrated in FIG. 11 in which a side elevational view of an exemplary seat 110 is illustrated. According to the applied testing method, the height of a head restraint 112 taken from the seat base 114 is assessed resulting in the finding of an R-point (or seating reference point) 116. The R-point 116, among other uses, defines the seat back angle.

Finally as noted, FIGS. 12 and 13 illustrate a test dummy as viewed using the technology of the disclosed system and method. The image of FIG. 12 illustrates a test dummy prior to an impact event. The image of FIG. 13 illustrates the same test dummy after the impact event.

With reference to FIG. 12, a vehicle interior 120 is illustrated. The vehicle interior 120 includes an array of image capturing devices. A test dummy 122 is illustrated in a typical occupant position prior to an impact event. In an impact test, one or more of the image capturing devices captures an image of the test dummy 122. The test dummy 122 is shown visualized using extended reality, augmented reality, and x-ray interpretations according to the disclosed inventive concept.

With reference to FIG. 13, the vehicle interior 120 and the test dummy 122 are illustrated following an impact event. Extended reality, augmented reality, and x-ray interpretations are again applied and are supported by artificial intelligence and predictive analytics to identify specific injuries. In the particular instance of FIG. 13, these injuries include crushing dash fractures at the wrist 124 and crushing floorboard fractures to the foot 126. The images generated in FIGS. 12 and 13 may also be generated by any of the impact tests illustrated in FIGS. 4 through 9. However, these images are not intended as being limiting as various occupant images including multiple occupants in the same test vehicle may be visualized according to the disclosed inventive concept.

As set forth above, the images generated according to the disclosed system and method are usable in a broad variety of applications including, but not limited to, use by medical support services for impact events involving a consumer vehicle and by automobile designers when interpreting crash test results. One skilled in the art will readily recognize from such discussion, and from the accompanying drawings and claims that various changes, modifications and variations can be made therein without departing from the true spirit and fair scope of the invention as defined by the following claims.

What is claimed is:

1. A method to modify an image of a vehicle occupant using different reality-enhancing applications, the vehicle having an interior, the method comprising:
forming an array of motion capturing imaging devices relative to the vehicle interior;
capturing occupant images using the imaging devices; and
applying an enhanced reality program to the captured images to generate an image illustrating one or more injuries to the occupant, the enhanced reality program including extended reality and augmented reality imaging.

2. The method to modify an image of a vehicle occupant of claim 1 wherein the generated image reveals damage that occurred inside the body of the occupant.

3. The method to modify an image of a vehicle occupant of claim 1 wherein the method is applied following an impact event.

4. The method to modify an image of a vehicle occupant of claim 1 wherein the enhanced reality program further includes virtual reality, artificial intelligence, and predictive analytics.

5. The method to modify an image of a vehicle occupant of claim 4 wherein the enhanced reality program generates a treatment protocol for the occupant's injuries.

6. The method to modify an image of a vehicle occupant of claim 5 wherein the treatment protocol is directed to a medical treatment unit.

7. The method to modify an image of a vehicle occupant of claim 1 wherein the enhanced reality program further includes a database for interpreting the injury to the occupant based on collected information related to previous occupant injuries.

8. The method to modify an image of a vehicle occupant of claim 1 wherein the enhanced reality program further includes a database for interpreting the injury to the occupant based on collected information related to previous occupant injuries.

9. The method to modify an image of a vehicle occupant of claim 1 wherein the method is used in the interpretation of impact injuries in a passenger vehicle.

10. The method to modify an image of a vehicle occupant of claim 1 wherein the method is used in the interpretation of impact injuries in a crash test vehicle.

11. A method to modify an image of a vehicle occupant using different reality-enhancing applications, the vehicle having an interior, the method comprising:
forming an array of motion capturing imaging devices relative to the vehicle interior;
capturing occupant images real time using the imaging devices; and
applying an enhanced reality program to the captured images to generate an image illustrating one or more injuries to the occupant, the enhanced reality program comprising extended reality, augmented reality, and virtual reality imaging modified by artificial intelligence and interpreted by predictive analytics.

12. The method to modify an image of a vehicle occupant of claim 11 wherein the enhanced reality program generates a treatment protocol for the occupant's injuries.

13. The method to modify an image of a vehicle occupant of claim 11 wherein the enhanced reality program further includes a database for interpreting the injury to the occupant based on collected information related to previous occupant injuries, the enhanced reality program further including a database for interpreting the injury to the occupant based on collected information related to previous occupant injuries.

14. The method to modify an image of a vehicle occupant of claim 11 wherein the method is used in the interpretation of impact injuries in a passenger vehicle.

15. The method to modify an image of a vehicle occupant of claim 11 wherein the method is used in the interpretation of impact injuries in a crash test vehicle.

16. A system for use in the interpretation of injury to an occupant within a vehicle as a result of an impact event, the vehicle having an interior, the system comprising:
an array of real-time motion capturing imaging devices within the vehicle interior;
databases, analysis tool programs, and software including programs for applying an enhanced reality program to the captured images to generate an image illustrating one or more injuries to the occupant, the enhanced reality program comprising extended reality, augmented reality, and virtual reality imaging modified by artificial intelligence and interpreted by predictive analytics; and
a transmitter to transmit the captured and interpreted images to a system user.

17. The system to modify an image of an occupant of a vehicle of claim 16 further including a database for interpreting the injury to the occupant based on collected information related to previous occupant injuries.

18. The system to modify an image of an occupant of a vehicle of claim 16 further including a health and biomechanics database.

19. The system to modify an image of an occupant of a vehicle of claim 16 further including a storage unit for storing real-time 3D images.

20. The system to modify an image of an occupant of a vehicle of claim 16 wherein the real-time motion capturing imaging devices utilize a markerless system for image capturing.
